(19) United States
(12) Patent Application Publication
(10) Pub. No.: US 2008/0095899 A1
(43) Pub. Date: Apr. 24, 2008

(54) METHOD AND APPARATUS FOR PRODUCING A MULTIPLE PHASE, CONFECTIONERY ARTICLE

(75) Inventor: Joan Fabre Fornaguera, Sant Cugat del Valles (ES)

Correspondence Address: BELL, BOYD & LLOYD LLP, P.O. Box 1135, CHICAGO, IL, 60690, US

(73) Assignee: WM. WRIGLEY JR. COMPANY, Chicago, IL (US)

(21) Appl. No.: 11/870,240

(22) Filed: Oct. 10, 2007

Related U.S. Application Data
(60) Provisional application No. 60/829,414, filed on Oct. 13, 2006.

(51) Int. Cl. A23G 3/54; A23G 3/12

(52) U.S. Cl. 426/103; 425/114; 426/516

(57) ABSTRACT

A method and apparatus for producing a multiple phase confectionery article is provided. The apparatus includes a rotary valve that is adapted to dispense a second confectionery material into a first confectionery material as the first confectionery material passes through the rotary valve. The apparatus may include a passageway that extends into the rotary valve, and the first confectionery material travels through the passageway. The rotary valve is rotatable to introduce the second confectionery material into the first confectionery material in a variety of ways to form an extrudate with a variety of multiple phase patterns.

### PRIORITY CLAIM

This application claims the benefit of U.S. Provisional Patent Application No. 60/829,414, filed Oct. 13, 2006, entitled “Method and Apparatus for Producing a Multiple Phase, Confectionery Article”, the entire contents of which are hereby incorporated by reference and relied upon.

### BACKGROUND

It is generally known that providing confectionery products in novelty shapes, compositions, and/or colors can lead to enhanced marketability, particularly with younger consumers. Pliable confectionery products, such as chewing gum for example, may be formed in the shape of sticks, pellets, and rolled tape in order to attract a wide array of different consumers. The confectionery products may be multi-colored or include a pattern of different colors or materials. Coextrusion of multiple confectionery materials is known in the art. The addition of a second confectionery material to a first confectionery material in order to form a pattern of the second confectionery material within the first confectionery material is generally difficult and may involve transferring the confectionery materials through multiple machines and processes. Confectionery products in which a confectionery material is painted onto a pre-formed confectionery article is known in the art. Confectionery products in which a confectionery material is manually placed onto a pre-formed confectionery material before coextruding or pressing together the pair of confectionery materials to form a finished product is also known in the art.

### SUMMARY

The present disclosure provides an apparatus and method for producing a multiple phase confectionery article that includes a first confectionery material and a second confectionery material. The second confectionery material forms a pattern in the first confectionery material. This is accomplished during manufacture through selective rotation of a rotary valve that extrudes the second confectionery material into the first confectionery material.

In an embodiment, an apparatus for producing a multiple phase confectionery article is provided. The apparatus includes a passageway that receives a first confectionery material and a rotary valve that surrounds the passageway. The rotary valve is configured to receive a second confectionery material. The rotary valve extrudes the second confectionery material into the first confectionery material. The confectionery forming apparatus forms an extrudate that includes at least the first and second confectionery materials. The rotary valve is rotatable about the passageway.

In an embodiment, the second confectionery material is continuously or non-continuously extruded from the rotary valve. In another embodiment, the second confectionery material is extruded to form a pattern of the second confectionery material in the first confectionery material. In another embodiment, the second confectionery material is extruded to form helical strands in the first confectionery material. In another embodiment, the second confectionery material is extruded to form zig-zag shaped strands in the first confectionery material. The first and second confectionery materials have different visual appearances.

In an embodiment, an apparatus for producing a multiple phase confectionery article is provided. The apparatus includes a passageway that receives a first confectionery material. The apparatus also includes a rotary valve that receives a second confectionery material. The rotary valve surrounds the passageway and extrudes the second confectionery material into the first confectionery material. The apparatus further includes a mandrel that receives a third confectionery material. The passageway surrounds the mandrel. The third confectionery material is dispensable through the mandrel into an extrudate formed of the first and second confectionery materials.

In an embodiment, the outer surface of the mandrel includes a plurality of helical grooves formed therein. In another embodiment, the mandrel is replaceable.

In an embodiment, an apparatus for producing a multiple phase confectionery article is provided. The apparatus includes a passageway that receives a first confectionery material. The apparatus also includes a rotary valve that receives a second confectionery material. The rotary valve includes a plurality of notches formed therein. The notches are movable into and out of fluid communication with the second confectionery material. The notches selectively extrude the second confectionery material into the first confectionery material.

In an embodiment, rotation of the rotary valve places the notches into or out of fluid communication with the second confectionery material. In another embodiment, the notches are in continuous fluid communication with the second confectionery material. In another embodiment, the notches are in non-continuous fluid communication with the second confectionery material. In yet another embodiment, rotation of the rotary valve starts or stops extrusion of the second confectionery material through the notches.

In an embodiment, an extrusion method is provided. The method includes extruding a first confectionery material through a passageway. The passageway is surrounded by a rotary valve. The method may further include extruding a second confectionery material through the rotary valve into the first confectionery material.

In an embodiment, the method further includes rotating the rotary valve to form a multiple phase pattern with the first and second confectionery materials. In another embodiment, the method further includes continuously rotating the rotary valve to form helical strands of the second confectionery material in the first confectionery material. In another embodiment, the method also includes rotating the rotary valve to form zig-zag shaped strands of the second confectionery material in the first confectionery material. In another embodiment, the method additionally includes rotating the rotary valve to form a random pattern of the second confectionery material in the first confectionery material.

In an embodiment, a confectionery article is provided. The confectionery article includes a substantially flat body having a top surface and a bottom surface. The body including at least a first confectionery material and a second confectionery material that form a pattern on the top and bottom surfaces. The pattern on the top surface is different than the pattern on the bottom surface.

In an embodiment, the body includes opposing lateral edges and the second confectionery material forms strands extending between the opposing lateral edges. In another embodiment, the second confectionery material forms zig-zag shaped strands in the first confectionery material. In another embodiment, the second confectionery material forms a random pattern in the first confectionery material on the top and bottom surfaces. In another embodiment, the first and second confectionery materials have different visual appearances.

In an embodiment, a confectionery article is provided. The confectionery article includes a tubular body. The tubular body includes a design that has portions of a first confectionery material formed within a second confectionery material.

In an embodiment, the first confectionery material forms substantially linear strands within the second confectionery material. In another embodiment, the first confectionery material forms non-continuous portions within the second confectionery material. In another embodiment, a third confectionery material is disposed within the tubular body.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE FIGURES

FIG. 1 is a perspective view of a confectionery forming apparatus extruding a confectionery extrudate in accordance with the present disclosure;

FIG. 2 is a perspective view of the confectionery forming apparatus of FIG. 1;

FIG. 3 is an exploded perspective view of the confectionery forming apparatus of FIG. 1;

FIG. 4 is a front elevation view of the confectionery forming apparatus of FIG. 1;

FIG. 5 is a cross-sectional view of the confectionery forming apparatus taken along line 5-5 of FIG. 4;

FIG. 6A is a perspective view of a mandrel in accordance with an embodiment of the present disclosure;

FIG. 6B is a perspective view of a mandrel in accordance with an embodiment of the present disclosure;

FIG. 7A is an exploded cut-away perspective view of a rotary valve and a housing in accordance with an embodiment of the present disclosure;

FIG. 7B is a cross-sectional view of the rotary valve and the housing along line 7B-7B of FIG. 7A;

FIG. 7C is an exploded cut-away perspective view of a rotary valve and housing in accordance with an embodiment of the present disclosure;

FIG. 7D is a cross-sectional view of the rotary valve and housing along line 7D-7D of FIG. 7C;

FIG. 8A is a perspective view of an extrudate in accordance with an embodiment of the present disclosure;

FIG. 8B is a perspective view of a slab formed from the extrudate of FIG. 8A in accordance with an embodiment of the present disclosure;

FIG. 8C is a perspective view of a confectionery article in accordance with an embodiment of the present disclosure;

FIG. 9A is a perspective view of an extrudate in accordance with an embodiment of the present disclosure;

FIG. 9B is a perspective view of a slab formed from the extrudate of FIG. 9A in accordance with an embodiment of the present disclosure;

FIG. 9C is a perspective view of a confectionery article in accordance with an embodiment of the present disclosure;

FIG. 10A is a perspective view of an extrudate in accordance with an embodiment of the present disclosure;

FIG. 10B is a perspective view of a slab formed from the extrudate of FIG. 10A in accordance with an embodiment of the present disclosure;

FIG. 10C is a perspective view of a confectionery article in accordance with an embodiment of the present disclosure;

FIG. 11A is a perspective view of an extrudate in accordance with an embodiment of the present disclosure;

FIG. 11B is a perspective view of a slab formed from the extrudate of FIG. 11A in accordance with an embodiment of the present disclosure;

FIG. 11C is a perspective view of a confectionery article in accordance with an embodiment of the present disclosure;

FIG. 12A is a perspective view of a confectionery article in accordance with an embodiment of the present disclosure; and

FIG. 12B is a perspective view of a confectionery article in accordance with an embodiment of the present disclosure.

FIG. 13 is a plan view of confectionery articles in accordance with an embodiment of the present disclosure.

FIG. 14 is a perspective view of a confectionery article in accordance with an embodiment of the present disclosure.

### DETAILED DESCRIPTION

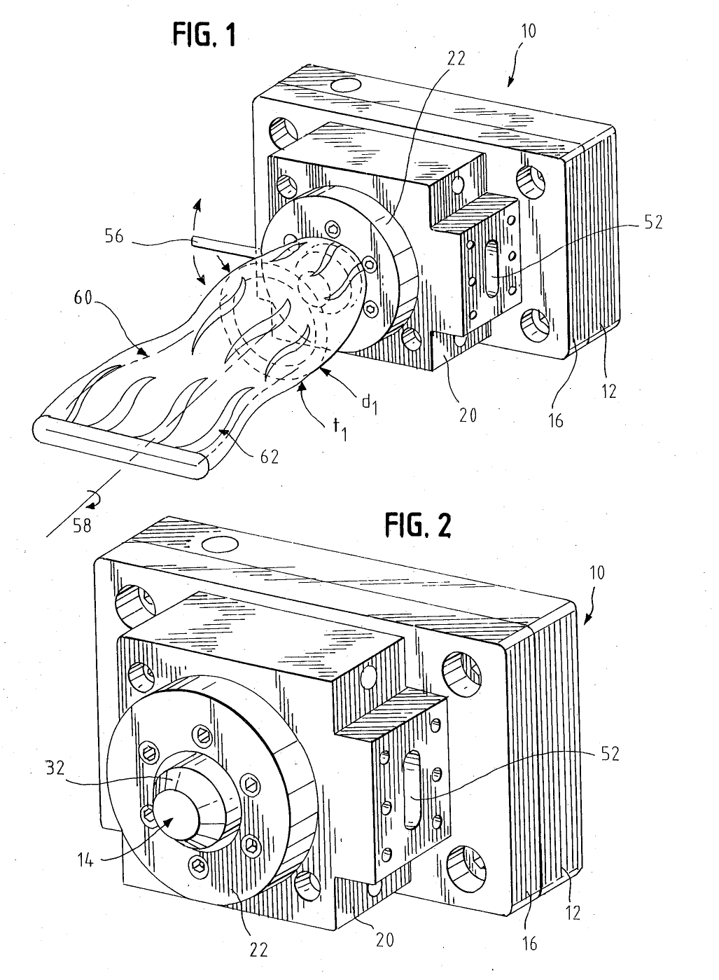

Referring to FIGS. 1-5, an embodiment of a confectionery forming apparatus for producing a multiple phase confectionery article is shown. The confectionery forming apparatus 10 may include a mounting plate 12, a mandrel 14, a forming plate 16, a rotary valve 18, a housing 20, and an actuator 22. The confectionery forming apparatus 10 is configured to produce an extrudate 60 containing at least two confectionery materials in which the two confectionery materials may have different visual appearances. The confectionery forming apparatus 10 may receive confectionery materials from a single source or from multiple sources. In an embodiment, a first confectionery material is input into the confectionery forming apparatus 10 by way of an extruder (not shown) connected to an inlet 24 of the mounting plate 12 to extrude the first confectionery material through a first passageway 26. A second confectionery material is input into the confectionery forming apparatus 10 by way of a second extruder (not shown) connected to the housing 20 to extrude or selectively extrude the second confectionery material into the first confectionery material. It should be understood by one skilled in the art that the mounting plate 12 may also include three, four, five, or more spaced-apart inlets for allowing a confectionery material to be input into the confectionery forming apparatus 10 from different sources or multiple different confectionery materials to be input into the confectionery forming apparatus 10 by way of the mounting plate 12.

In an embodiment, the mounting plate 12 may be formed as a rectangular or substantially rectangular member, as illustrated in FIG. 2. It should be understood by one skilled in the art that the mounting plate 12 may be square, circular, oval, oblong, or any other shape as desired sufficient to be operatively connected to at least one extruder. The mounting plate 12 includes an aperture formed through the thickness to provide a first inlet 24 into the confectionery forming apparatus 10, as shown in FIG. 5. In an embodiment, the first inlet 24 may be formed as a circular aperture, but the first inlet 24 may also be formed as any shape sufficient to receive a first confectionery material from an extruder through the first inlet 24. In an embodiment, a single extruder may be operatively connected to the mounting plate 12 to extrude a first confectionery material through the first inlet 24. In another embodiment, a plurality of extruders may be attached to the mounting plate 12 such that each extruder extrudes a different confectionery material through the first inlet 24. In another embodiment, multiple extruders may be operatively connected to the mounting plate 12 at separate, spaced-apart inlets that are in fluid communication with the first inlet 24. The mounting plate 12 may be formed of steel, aluminum, plastic, thermoplastic, or any other material sufficient to allow at least one confectionery material to flow freely through the first inlet 24 as well as be chemically inert with respect to the confectionery material being extruded therethrough.

The first confectionery material may be any soft candy, chewing gum, or other confectionery substance, or compound that has a fluid phase or may take a fluid or a pliable form. In other words, the first confectionery material may be heated or melted, form a syrup, or be dissolved in a liquid to become flowable or fluid as is commonly known in the art such that the first confectionery material may be extruded from the extruder through the confectionery forming apparatus 10. Examples of materials that may be used for the first confectionery material include, but are not limited to, chewing gum, bubble gum, nougat, pliable confectionery material, taffy, soft candy, chewy candy, caramel, or any combination thereof.

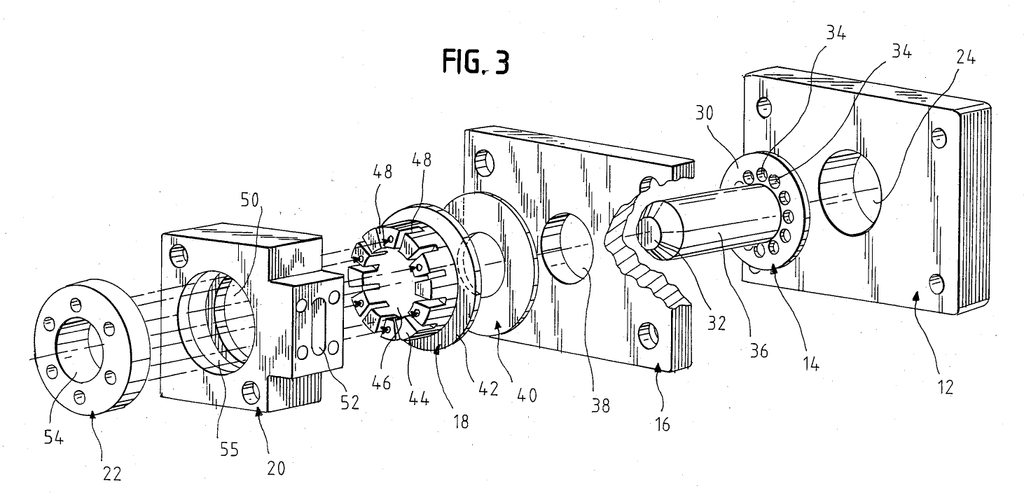

A mandrel 14 is disposed between the mounting plate 12 and the forming plate 16, as illustrated in FIGS. 3 and 5. In an embodiment, the mandrel 14 may be attached to the mounting plate 12 by a weld, rivet, or any other securing mechanism sufficient to provide a rigid or substantially rigid connection between the mandrel 14 and the mounting plate 12. In another embodiment, the mandrel 14 may be attached to the forming plate 16 by a weld, rivet, or any other securing mechanism sufficient to provide a rigid or substantially rigid connection between the mandrel 14 and the forming plate 16. In another embodiment, the mandrel 14 may be secured between the mounting plate 12 and the forming plate 16 such that the mandrel 14 is attached to neither the mounting plate 12 nor the forming plate 16. In another embodiment, the mandrel 14 and the mounting plate 16 may be formed as a single member. In yet another embodiment, the mandrel 14 and the forming plate 16 may be formed as a single member. In another embodiment, the mandrel 14 may be releasably attachable to either the mounting plate 12 or the forming plate 16.

In an embodiment, the mandrel 14 may include a base 30 and an elongated pin 32 extending from the base 30, as shown in FIG. 3. The base 30 may be formed as a circular or substantially circular member, but it should be understood by one skilled in the art that the base 30 may be formed as any shape sufficient to be located and secured between the mounting plate 12 and the forming plate 16. The size of the base 30 may be greater than the diameter of the first inlet 24 to ensure that confectionery material does not leak around the edge of the base 30 as it is extruded through the first inlet 24. In another embodiment, the diameter 30 of the base is the same as or substantially the same as the diameter of the first inlet 24.

The base 30 may include a plurality of apertures 34 formed therethrough, as shown in FIGS. 3-5. In an embodiment, twelve (12) apertures 34 may be formed through the base 30 of the mandrel 14. In another embodiment, the base 30 may include a single, centrally located aperture 34 formed through the base 30. It should be understood by one skilled in the art that any number of apertures 34 may be formed through the base 30 to allow the confectionery material to pass therethrough. The apertures 34 are in fluid communication with the first inlet 24 such that the confectionery material from the first extruder passes through the first inlet 24 of the mounting plate 12 then through the apertures 34 in the base 30 of the mandrel 14. The apertures are also in fluid communication with the first passageway 26 into which the first confectionery material is extruded after passing through the apertures 34. The apertures 34 may be disposed adjacent to the outer edge of the base 30. The apertures 24 may be shaped as circular holes through the thickness of the base 30, but it should be understood by one skilled in the art that the apertures 34 may be formed as any shape sufficient to allow confectionery material to pass therethrough. Varying the size, shape, and number of apertures 34 formed through the base 30 may provide different flow rates of the confectionery material through the apertures 34, given a constant flow of confectionery material from the extruder.

In an embodiment, the pin 32 of the mandrel 14 extends from the base 30 in a perpendicular or substantially perpendicular manner relative to the planar orientation of the base 30, as illustrated in FIG. 3. In an embodiment, the pin 32 may be an elongated cylindrical member having an outer surface 36. The apertures 34 of the base 30 of the mandrel 14 are disposed radially outward relative to the outer surface 36 of the pin 32 such that the confectionery material that flows through the apertures 34 passes over the outer surface 36 of the pin 32. In an embodiment, the outer surface 36 of the pin 32 includes a plurality of helical grooves 35, as illustrated in FIG. 6A. As the first confectionery material passes over the outer surface 36 of the pin 32, the helical grooves 35 cause the first confectionery material to rotate or twist about the longitudinal axis of the pin 32. In another embodiment, the outer surface 36 of the pin 32 is smooth, as shown in FIGS. 3 and 6B, thereby allowing the confectionery material to freely flow over the outer surface 36 of the pin 32. The outer surface 36 of the pin 32 may also be chemically inert relative to the confectionery material dispensed through the apertures 34 in the base 30 of the mandrel 14. It should be understood by one skilled in the art that the outer surface 36 of the pin 32 may include different surface treatments, grooves, protrusions, or other effects designed to control the flow rate or flow path of the confectionery material over the outer surface 36 of the pin 32.

The outer surface 36 of the pin 32 is adapted to aid in the formation of a tubular-shaped confectionery article within the confectionery forming apparatus 10. In an embodiment, the pin 32 may have a round cross-section, as illustrated in FIGS. 6A-6B, thereby producing a tubular confectionery article having a circular cross-sectional center. It another embodiment, the pin 32 may have a square cross-section (not shown), thereby producing a tubular confectionery article having a square cross-sectional center. It should be understood by one skilled in the art that the cross-section of the pin 32 may be any shape sufficient to allow a confectionery material to pass over the outer surface 36 thereof to produce a tubular confectionery article being formed with an inner surface having substantially the same shape as the outer surface 36 of the pin 32. In another embodiment, the mandrel 14 includes a centrally located aperture (not shown), without a pin, thereby forming a cylindrical or substantially cylindrical rope of the first confectionery material. In another embodiment, the mandrel 14 may include only the apertures 34 formed therethrough, wherein extrusion of the first confectionery material forms a cylindrical or substantially cylindrical extrudate. In another embodiment, the confectionery forming apparatus 10 does not have a mandrel 14 such that the confectionery material flows directly from the mounting plate 12 to the forming plate 16.

In an embodiment, the pin 32 may include an aperture formed through the entire center of the pin 32, as illustrated in FIG. 6B. The aperture through the pin 32 forms a third passageway 37 from which a third confectionery material may be dispensable. The third confectionery material may be extruded or pumped through the third passageway 37 for dispensing into the center of a tubular confectionery article being extruded from the confectionery forming apparatus 10. Examples of suitable confectionery materials that may be extruded, pumped, or dispensed through the third passageway 37 include, but not limited to, paste, gel, syrup, liquid, fondant, toffee, taffy, jelly, chewing gum, chocolate, gelatin, nougat, or solids for making hard candies, soft candies, or any combination thereof. The third confectionery material dispensed through the third passageway 37 may form a center, or filling layer within the extruded confectionery article.

The mandrel 14 may be replaceably disposed between the mounting plate 12 and the forming plate 12, as illustrated in FIGS. 3 and 5. The mandrel 14 may be replaceable for regular maintenance or for repair. The mandrel 14 may also be replaced by another mandrel having different characteristics that may change the formation of the confectionery article that is extruded from the confectionery forming apparatus 10. For example, the mandrel 14 having a pin 32 with a smooth outer surface (FIG. 3) may be replaced with a mandrel 14 having a pin 32 with a third passageway 37 formed through the pin 32 (FIG. 6B) through which a gel may be dispensed to form a tubular confectionery article having a gel center. For another example, a mandrel 14 having a pin 32 with a first outer diameter may be replaced by another mandrel 14 having a pin 32 with a second, smaller outer diameter such that the confectionery forming apparatus 10 may extrude a tubular confectionery article having a larger wall thickness. For another example, a mandrel 14 having a pin 32 may be removed such that the confectionery forming apparatus 10 may extrude a cylindrical rope of confectionery material. It should be understood by one skilled in the art that the mandrel is replaceable such that the operator may selectively modify various aspects of the formation of the first confectionery material as it is extruded through the confectionery forming apparatus 10. Aspects of the mandrel 14 that may vary upon replacing the mandrel 14 include, but are not limited to, outer diameter of the pin 32, length of the pin 32, grooves 35 formed in the outer surface 36 of the pin 32, number of apertures 34 formed through the base 30, presence or absence of a pin 32, and an third passageway 37 formed within the pin 32.

The pin 32 of the mandrel 14 may be received within the forming plate 16, as illustrated in FIGS. 3 and 5. The forming plate 16 may be a generally rectangular member and substantially the same size and shape as the mounting plate 12, as illustrated in FIGS. 1-3. When the confectionery forming apparatus 10 is assembled, the forming plate 16 may be disposed adjacent to the mounting plate 12. In an embodiment, the mounting plate 12 may include a detent (not shown) adapted to receive the base 30 of the mandrel 14 such that the mounting plate 12 and the forming plate 16 may be attached in an abutting manner with the base 30 of the mandrel 14 being disposed within the detent. In another embodiment, the forming plate 16 may include a detent (FIG. 5) adapted to receive the base 30 of the mandrel 14 such that the mounting plate 12 and the forming plate 16 may be attached in an abutting manner with the base 30 of the mandrel 14 being disposed within the detent. In yet another embodiment, the mandrel 14 may be disposed between the mounting plate 12 and the forming plate 16 such that the mounting plate 12 and the forming plate 16 may be attached in an adjacent, spaced-apart manner. The base 30 of the mandrel may be disposed adjacent to the mounting plate 12 such that the pin 32 extends away from the mounting plate 12 and is received by an aperture 38 formed through the forming plate 16.

The forming plate 16 includes an aperture 38 that is formed through the thickness of the forming plate 16, as shown in FIGS. 3 and 5. The diameter of the aperture 38 may be greater than the outer diameter of the pin 32 of the mandrel 14 such that the inner surface of the aperture 38 is spaced apart from the outer surface 36 of the pin 32 of the mandrel 14. The forming plate 16 may be adapted to receive the first confectionery material through the aperture 38. As the first confectionery material passes through the apertures 34 formed in the base 30 of the mandrel 14, the first confectionery material may fill the gap between the outer surface 36 of the pin 32 and the inner surface of the aperture 38, thereby forming a tubular confectionery article within the first passageway 26. The tubular confectionery article exiting the aperture 38 of the forming plate 16 may have an outer diameter that is the same or substantially the same as the diameter of the aperture 38.

When the confectionery forming apparatus 10 is assembled, the rotary valve 18 may be located adjacent to the forming plate 16, as illustrated in FIGS. 3 and 5, such that a washer 40 is disposed between the rotary valve 18 and the forming plate 16 to allow the rotary valve 18 to rotate relative to the forming plate 16. The rotary valve 18 may include a spacer 42 and a body 44. The rotary valve 18 may be an elongated, tubular or substantially tubular-shaped member having an aperture 46 extending through the center of the rotary valve 18. The pin 32 of the mandrel 14 may be adapted to extend through the aperture 38 of the forming plate 16 and be received within the aperture 46 of the rotary valve 18 such that the aperture 38 of the forming plate 16 and the aperture 46 of the rotary valve 18 are disposed about the outer surface 36 of the pin 32 in a generally concentric manner. The rotary valve 18 may be rotatable about the longitudinal axis of the pin 32 of the mandrel 14. The diameter of the aperture 46 of the rotary valve 18 may be the same or substantially the same as the diameter of the aperture 38 of the forming plate 16 such that the apertures 38, 46 may be aligned to provide a consistent distance between the forming plate 16 and rotary valve 18 about the pin 32 of the mandrel 14.

The body 44 of the rotary valve 18 may be an elongated, cylindrical or substantially cylindrical member that extends in a perpendicular or substantially perpendicular manner from the spacer 42, as shown in FIG. 3. The spacer 42 may be a circular member having an outer diameter that is larger than the outer diameter of the body 44. The spacer 42 provides a contact surface, opposite the surface to which the body 44 is attached, wherein the contact surface is in abutting, sliding engagement with the washer 40. In one embodiment, the spacer 42 and the body 44 may be formed as a single member. In another embodiment, the spacer 42 may be attached to the body 44 by a securing mechanism. The body 44 of the rotary valve 18 extends from the spacer 42 and is received within an aperture 50 formed through the housing 20.

The rotary valve 18 may include a plurality of notches 48 formed through the thickness of the rotary valve 18, as shown in FIGS. 3 and 5. The notches 48 may be placed in selective fluid communication with the second confectionery material transferred from the second extruder (not shown) and the first passageway 26. The second confectionery material may be any soft candy, chewing gum, or other confectionery substance, or compound that has a fluid phase or may take a fluid or a pliable form. In other words, the second confectionery material may be heated or melted, form a syrup, or be dissolved in a liquid to become flowable or fluid as is commonly known in the art. Examples of materials that may be used for the second confectionery material include, but are not limited to, chewing gum, bubble gum, nougat, pliable confectionery material, taffy, soft candy, chewy candy, caramel, or any combination thereof.

The notches 48 may allow the second confectionery material to be extruded into the first passageway 26 in a selective manner. In an embodiment, the notches 48 may be formed as elongated slots through the entire wall thickness of the body 44. The notches 48 may have a rectangular or substantially rectangular shape and may be aligned parallel or substantially parallel to the longitudinal axis of the pin 32. In another embodiment, the notches 48 may be formed as elongated slots having a rectangular or substantially rectangular shape and aligned perpendicular or substantially perpendicular to the longitudinal axis of the pin 32. In another embodiment, the notches 48 may be shaped as round or substantially round apertures formed through the body 44 of the rotary valve 18. It should be understood by one skilled in the art that the notches 48 formed in the rotary valve 18 may be of any shape or size sufficient to allow a second confectionery material to be transferred through the notches 48 into the first passageway 26. In an embodiment, the rotary valve 18 includes twelve (12) notches 48 equally spaced about the circumference of the rotary valve 18, and the notches 48 extend longitudinally inward from the end of the body 44 of the rotary valve 18. It should be understood by one skilled in the art that any number of notches 48 may be formed in the rotary valve 18 to allow the transfer of at least a second confectionery material therethrough.

In an embodiment, the notches 48 may be aligned about the circumference of the rotary valve 18 at the same or substantially the same distance from the end of the rotary valve 18, but any number of rows of notches 48 may be formed about the circumference of the rotary valve 18. In another embodiment, the rotary valve 18 may include at least one row of notches 48 having a first shape and size and at least a second row of notches 48 having a different shape and size than the first row. In another embodiment, the rotary valve 18 may include notches 48 formed on only one half of the body 44 such that the second confectionery material may only pass through the rotary valve 18 through an upper or lower half of the rotary valve 18.

In an embodiment, the notches 48 formed through the rotary valve 18 may be evenly spaced-apart about the circumference of the rotary valve 18, as illustrated in FIG. 3. In another embodiment, the notches 48 may be unevenly spaced about the circumference of the rotary valve 18. The notches 48 are adapted to be selectively alignable or placed in fluid communication with corresponding ports 57 located within the housing 20, as shown in FIG. 5 and explained below, thereby allowing a second confectionery material to be selectively extruded into the first passageway 26 formed about the pin 32 of the mandrel 14.

The housing 20 may be adapted to receive the pin 32 of the mandrel 14 as well as the body 44 of the rotary valve 18 within an aperture 50 formed through the housing 20, as illustrated in FIGS. 3 and 5. The housing 20 may include an inlet 52 that is operatively connected to a second extruder (not shown). In an embodiment, the inlet 52 may extend from a side of the housing 20. It should be understood by one skilled in the art that the housing 20 may include any number of inlets or passageways for receiving multiple confectionery materials. The housing 20 may be secured to the forming plate 16 in an abutting manner. The housing 20 may be adapted to enclose the rotary valve 18 therewithin when the housing 20 is attached to the forming plate 16.

The housing 20 may include a second passageway 55 that is disposed about at least a portion of the circumference of the aperture 50, as illustrated in FIGS. 3, 5, and 7A-7D. The second passageway 55 is adapted to receive the second confectionery material that is transferred from the second extruder through the inlet 52 of the housing 20. The second passageway 55 may be formed into the surface of the aperture 50. In an embodiment, the second passageway 55 may be disposed about the entire circumference of the aperture 50. In another embodiment, the second passageway 55 may be disposed about a portion of the circumference of the aperture 50. In an embodiment, the second passageway 55 may be open, or exposed, within the aperture 50 such that the second confectionery material within the second passageway 55 is in continuous fluid communication with the rotary valve 18. In other words, the second passageway 55 may surround or substantially surround the entire circumference of the rotary valve 18. In another embodiment, the second passageway 55 may be covered and include a plurality of ports 57 that allow the second confectionery material to be transferred from the second passageway 55 to the first passageway 26.

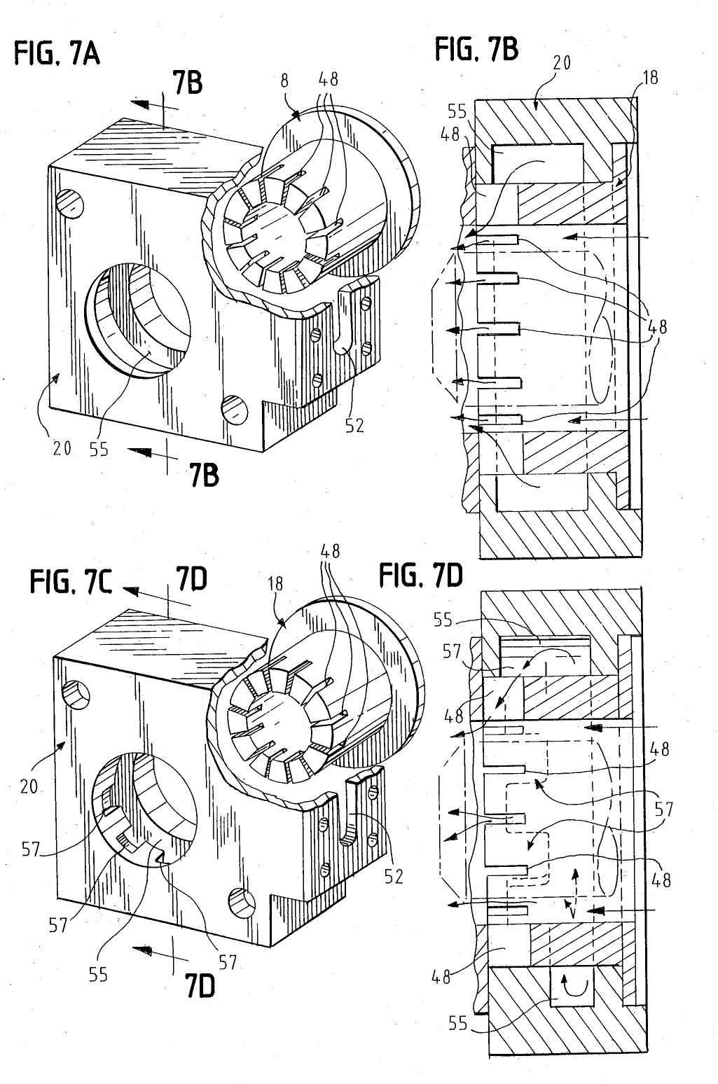

Referring to FIGS. 7A-7D, the second cavity 55 disposed within the housing 20 may be configured to provide either a continuous or non-continuous flow of the second confectionery material into the first confectionery material. In an embodiment, the second passageway 55 may be formed such that the width of the channel in the housing 20 overlaps with the notches 48 formed in the rotary valve 18 such that the notches 48 are in continuous fluid communication with the second passageway 55, thereby providing a continuous flow rate of the second confectionery material from the housing 20 into the first confectionery material in the first passageway 26, as shown in FIGS. 7A-7B. In another embodiment, the second passageway 55 may be formed such that the width of the channel in the housing 20 does not overlap with the notches 48 formed in the rotary valve 18. The second passageway 55 may include a plurality of spaced-apart ports 57, wherein the ports 57 extend from the second passageway 55 a distance sufficient to overlap with the notches 48 of the rotary valve 18, as shown in FIG. 7D. Rotation of the rotary valve 18 places the notches 48 into and out of alignment, or places into and out of fluid communication, with the ports 57, thereby starting and stopping, respectively, the extrusion of the second confectionery material from the second passageway 55 into the first confectionery material.

When at least one notch 48 in the rotary valve 18 is aligned, or placed in fluid communication, with a port 57 in the housing 20, the second confectionery material may be extruded into the first passageway 26. When none of the notches 48 are aligned, or placed in fluid communication, with a port 57, the extrusion of the second confectionery material into the first passageway 26 is stopped. Rotation of the rotary valve 18 may provide a non-continuous flow rate of the second confectionery material into the first confectionery material located within the first passageway 26 as the notches 48 become aligned and non-aligned, or placed into and out of fluid communication, with corresponding ports 57. The rotary valve 18 may be selectively rotated to increase, decrease, start, or stop the flow of the second confectionery material from the second passageway 55 into the first confectionery material in the first passageway 26 by selectively rotating the rotary valve 18.

The body 44 of the rotary valve 18 may extend through the aperture 50 formed in the housing 20, and an actuator 22 may be attached to the end of the body 44 of the rotary valve 18 that is opposite the end to which the spacer 42 is connected, as shown in FIGS. 3 and 5. The body 44 of the rotary valve 18 may extend through the housing 20 such that the spacer 42 is disposed adjacent to the housing 20 and the actuator 22 is disposed adjacent to the opposing outer surface of the housing 20. The actuator 22 may be removably attached to the rotary valve 18 to allow the confectionery forming apparatus 10 to be easily assembled or disassembled and also allowing the rotary valve 18 and/or the mandrel 14 to be replaced. The actuator 22 may be a cylindrical or a substantially cylindrical member having an aperture 54 formed therethrough. The aperture 54 in the actuator 22 may be adapted to receive the pin 32 of the mandrel 14. The diameter of the aperture 54 may be the same or substantially the same as the diameter of the aperture 46 of the rotary valve 18 such that when the rotary valve 18 is attached to the actuator 22, the apertures 46, 54 are aligned to form a portion of the first passageway 26 through the rotary valve 18 and actuator 22 having a consistent diameter with respect to the pin 32. The actuator 22 may be attached to the rotary valve 18 by way of bolts, pins, or any other securing mechanism sufficient to connect the actuator 22 to the rotary valve 18 in a releasably rigid manner.

In an embodiment, continuous rotation of the rotary valve 18 may place the notches 48 into and out of alignment, or placed into and out of fluid communication, with the ports 57 such that the second confectionery material is extruded into the first confectionery material within the first passageway 26 in a random, or non-continuous manner, as illustrated in FIGS. 7C-7D. In another embodiment, the rotary valve 18 may be selectively rotated in the clockwise and/or counter-clockwise directions in a random manner such that the notches 48 are randomly aligned, or placed into fluid communication, with corresponding ports 57 for random extrusion of the second confectionery material into the first passageway 26. It should be understood by one skilled in the art that the manner in which the rotary valve 18 may be maintained in a stationary position in which the notches 48 remain in continuous fluid communication with the second passageway 55 for continuous extrusion of the second confectionery material into the first passageway 26.

The actuator 22 may be rotatable about the longitudinal axis of the pin 32 of the mandrel 14, and rotation of the actuator 22 may cause the rotary valve 18 to rotate about the longitudinal axis of the pin 32 of the mandrel 14 in a like manner. Rotation of the rotary valve 18 may be dependent upon the rotation of the actuator 22. The actuator 22 may be rotatable in the clockwise and counter-clockwise directions about the longitudinal axis of the pin 32 of the mandrel 14.

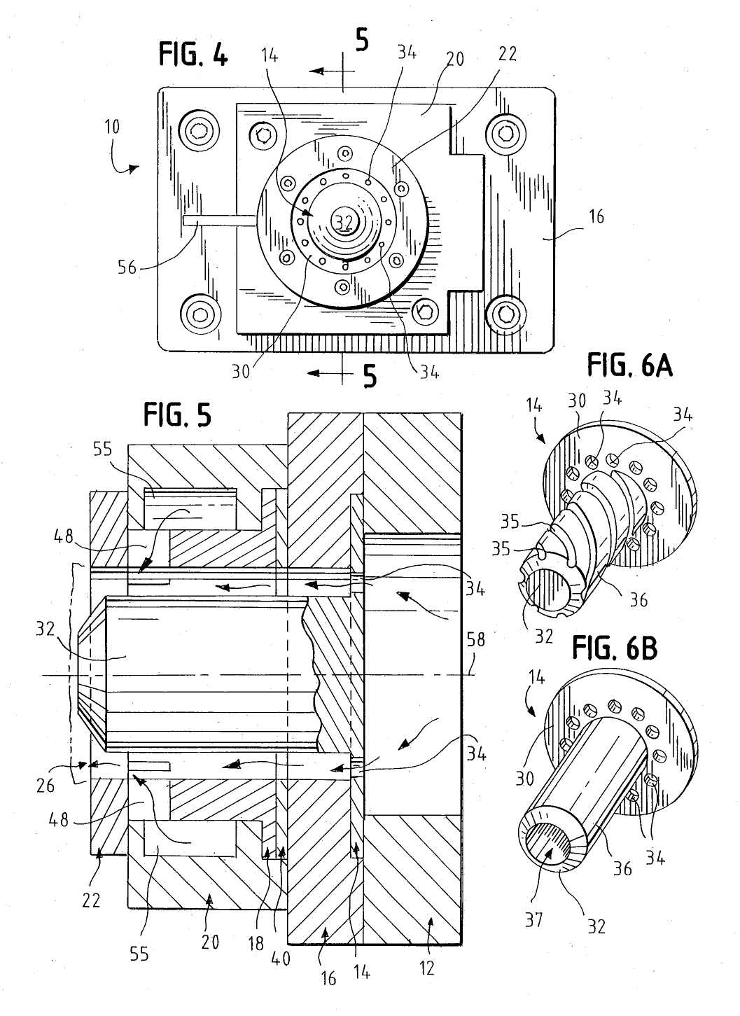

In an embodiment, the actuator 22 may include a lever 56 extending therefrom, as shown in FIGS. 1 and 4. The lever 56 may be used to rotate the actuator 22 about the longitudinal axis of the pin 32 of the mandrel 14. In an embodiment, the lever 56 may be manually actuated to cause the actuator 22 and rotary valve 18 to rotate. In another embodiment, the lever 56 may be mechanically actuated to cause the actuator 22 and rotary valve 18 to rotate. In yet another embodiment, the actuator 22 does not include a lever 56, yet the actuator 22 and rotary valve 18 may be rotated either manually or mechanically without the assistance of the lever 56. In yet a further embodiment, apparatus 10 may include a drive device (not shown) operatively connected to actuator 22 to automatically drive or otherwise rotate actuator 22 as desired. The drive device may be any device capable of rotating rotary valve 18. In an embodiment, the drive device may include a gear box which may be operatively connected to a reducer which may be operatively connected to a servo motor which may be operatively connected to actuator 22.

During operation (automatic or manual), the actuator 22 and rotary valve 18 may be selectively rotated in a variety of manners including, but not limited to, a clockwise direction at a constant angular velocity, a counterclockwise direction at a constant angular velocity, back-and-forth motion in both directions in a reciprocating manner, back-and-forth motion in the clockwise and counter-clockwise directions in a random manner, at variable angular velocities in either or both directions, in a start-and-stop manner in the clockwise and/or counter-clockwise directions, or remain stationary relative to the pin 32. It should be understood by one skilled in the art that actuator 22 (and rotary valve 18) may be rotated in any desired manner to selectively dispense the second confectionery material into the first passageway 26.

In an embodiment, the confectionery forming apparatus 10 may be assembled, as shown in FIGS. 1-5, such that the forming plate 16 is attached to the mounting plate 12 such that a mandrel 14 may be disposed therebetween. The housing 20 may be attached to the forming plate 16 such that the housing 20 surrounds the rotary valve 18, and the body 44 of the rotary valve 18 extends through the aperture 50 of the housing 20. The actuator 22 may be attached to the rotary valve 18 such that the actuator 22 is located adjacent to the side of the housing 20 opposite the side of the housing 20 attached to the forming plate 16. The pin 32 may extend from the base 30 of the mandrel 14 through the rotary valve 18, housing 20, and actuator 22 in a spaced-apart manner. The first passageway 26 may be formed between the outer surface 36 of the pin 32 and the inner surface of the aperture 38 in the forming plate 16, the aperture 46 in the rotary valve 18, and the aperture 54 in the actuator 22. The first passageway 26 forms a flow axis 58 (FIG. 5) along the length of the pin 32, and the flow axis 58 may be parallel or substantially parallel to the longitudinal axis of the pin 32. In another embodiment in which the mandrel 14 does not include a pin 32, the first passageway 26 is formed within the aligned apertures 24, 38, 46, 54. The rotary valve 18 may be located around the first passageway 26, and the rotary valve 18 may be rotatable about the flow axis 58 of the first confectionery material flowing within the first passageway 26 in both the clockwise and counterclockwise directions. The rotary valve 18 may be manually or mechanically rotated about the flow axis 58. Rotation of the rotary valve 18 about the flow axis 58 of the first passageway may cause the first and/or second confectionery materials to likewise rotate, or twist, about the flow axis 58. In another embodiment, the confectionery forming apparatus 10 does not include a mandrel 14 such that the first confectionery material may be extruded through the first passageway 26 as a rope.

In an embodiment, the first passageway 26 may be annular or tubular shaped as the first passageway 26 extends between the outer surface 36 of the pin 32 and the forming plate 16, rotary valve 18, and actuator 22 that are disposed around the pin 32. In an embodiment, the apertures 38, 46, 54 have the same or substantially the same diameter, and the apertures 38, 46, 54 are aligned in a concentric or substantially concentric manner about the pin 32 such that the distance between the pin 32 and the apertures 38, 46, 54 remains the same or substantially the same along the entire length of the first passageway 26. In another embodiment, the diameter of the apertures 38, 46, 54 decreases such that the space between the apertures 38, 46, 54 and the outer surface 36 of the pin 32 gradually decreases between the base 30 of the mandrel 14 and the outer surface of the actuator 22 such that the thickness of the extrudate within the first passageway 26 decreases as the extrudate extends along the length of the first passageway 26. In another embodiment, if the confectionery forming apparatus 10 includes a mandrel 14 having a third passageway 37 for dispensing a third confectionery material, the first passageway 26 may be located around both the mandrel 14 and the third passageway 37 in a concentric or substantially concentric manner.

In operation, a first extruder (not shown) may be operatively connected to the confectionery forming apparatus 10 to deliver a first confectionery material to the first inlet 24 formed in the mounting plate 12. The first confectionery material may pass through the first inlet 24 and then through the apertures 34 formed in the base 30 of the mandrel 14. As the first confectionery material passes through the apertures 34 in the mandrel 14 into the first passageway 26, the first passageway 26 becomes filled with the first confectionery material. In an embodiment, the outer surface 36 of the pin 32 may include a plurality of helically-shaped grooves 35 (FIG. 6A) formed therein such that as more of the first confectionery material is dispensed through the apertures 34 in the mandrel 14, the first confectionery material flows in a twisting, helical manner along and about the pin 32 within the first passageway 26. The first confectionery material may extend within the first passageway 26 through the rotary valve 18 and the actuator 22 until an extrudate 60 exits the actuator 22, as shown in FIG. 1. It should be understood by one skilled in the art that the movement or flow of the first confectionery material 64 through the first passageway 26 may be effected by the surface effects on the outer surface 36 of the pin 32, and the operator may replace the mandrel 14 to selectively modify the movement or flow of the first confectionery material 64 within the first passageway 26.

A second extruder (not shown) may be operatively connected to the confectionery forming apparatus 10 to deliver a second confectionery material 66 to the inlet 52 of the housing 20. The second confectionery material 66 may be transferred through the inlet 52 in the housing 20 to a second passageway 55 located about the aperture 50. As the second confectionery material 66 fills the second passageway 55, the second confectionery material may be in fluid communication with the rotary valve 18. When the rotary valve 18 is rotated such that at least one notch 48 on the rotary valve 18 is aligned, or placed in fluid communication, with a corresponding port 57 in the housing 20, the second confectionery material 66 is extruded from the port 57 through the notch 48 and into the first passageway 26, thereby forming segmented portions 62 of the second confectionery material in the first confectionery material.

In an embodiment, housing 20 may be configured with two, three, four, five, or more inlets, each inlet receiving a respective confectionery material. Each additional inlet may be in fluid communication with passageway 55 to deliver, extrude, co-extrude, or otherwise introduce more than two confectionery materials into the extrusion flow of first confectionery material 64. In other words, housing 20 may be configured to introduce two, three, four, five or more confectionery materials (vis-à-vis rotary valve 18) into first confectionery material 64. In an embodiment, passageway 55 may include dividers to segregate the multiple confectionery materials flowing from each respective inlet. In a further embodiment, each additional inlet may be placed in fluid communication with one or more ports 57. Thus, each additional confectionery material fed into housing 20 may be introduced into first confectionery material 64 similar to the manner in which second confectionery material 66 is introduced or otherwise extruded into first confectionery material 64.

In an embodiment, each confectionery material (i.e., a single confectionery material or a plurality of confectionery materials) extruded through housing 20 may be fed by a dedicated extruder, a dedicated gear pump, or a dedicated lobe pump as is commonly known in the art. In yet a further embodiment, each confectionery material extruded through housing 20 may be delivered by way of a dedicated lobe pump, each lobe pump capable of feeding each confectionery material through housing 20 and through rotary valve 18 at a pressure from about 35 bar to about 45 bar.

The rotary valve 18 may be located around the first passageway 26 in a concentric or substantially concentric manner, as illustrated in FIGS. 4-5. The notches of the rotary valve 18 may be in selective fluid communication with the second confectionery material 66 as the notches 48 are placed into alignment, or placed into fluid communication, with the ports 57 (FIG. 7D) or the second passageway 55 (FIG. 7B). As the rotary valve 18 is rotated, the location of the notches 48 formed in the rotary valve 18 likewise rotate to different positions relative to the first passageway 26 such that the second confectionery material 66 may be dispensed from a particular notch 48 at different locations about the first passageway 26.

The confectionery forming apparatus 10 may be adapted to produce a multiple phase extrudate 60, as shown in FIG. 1, that includes at least the first confectionery material 64 and segmented portions 62 of the second confectionery material 66. The extrudate 60 may be further manipulated to form a finished product. The segmented portions 62 of the second confectionery material 66 may form a pattern in the first confectionery material 64, and the first and second confectionery materials 64, 66 may have different visual properties. The different visual properties between the confectionery materials 64, 66 may include, but not limited to, color, texture, type of material, viscosity, or any combination thereof. It should be understood by one skilled in the art that the first and second confectionery materials 64, 66 may have multiple visual differences that differentiate between the materials such that the second confectionery material 66 forms a distinctive pattern in the first confectionery material 64.

In an embodiment, the extrudate 60 exiting the confectionery forming apparatus 10 may be formed as an annular tube having a wall thickness t₁ that may be equal or substantially equal to the radial distance between the outer surface 36 of the pin 32 of the mandrel 14 and the inner surface of the aperture 54 formed through the actuator 22. The extrudate 60 further has a outer diameter d₁ that may be equal or substantially equal to the diameter of the inner surface of the aperture 54 through the actuator 22. In an embodiment, the extrudate 60 may have an outer diameter d₁ of about nine inches (9 in.) and a wall thickness t₁ of about one-quarter inch (¼ in.). In another embodiment, the mandrel 14 may be replaced with another mandrel in which the diameter of the outer surface 36 of the pin 32 is smaller, thereby producing a tubular extrudate 60 having an outer diameter d₁ of about nine inches (9 in.) and a wall thickness t₁ of about one-half inch (½ in.). It should be understood by one skilled in the art that the outer diameter d₁ and wall thickness t₁ of the extrudate 60 may be selectively variable, and the outer diameter d₁ of the extrudate 60 may be between about one-half and twenty-four inches (½-24 in.) and the wall thickness t₁ of the extrudate 60 may be between about one-sixteenth and one and a half inches ( 1/16-1.5 in.). In another embodiment, the mandrel 14 may be removed such that the confectionery forming apparatus 10 forms an extrudate shaped as a solid cylindrical rope in which the outer diameter of the extrudate 60 is equal or substantially equal to the diameter of the aperture 54 of the actuator 22.

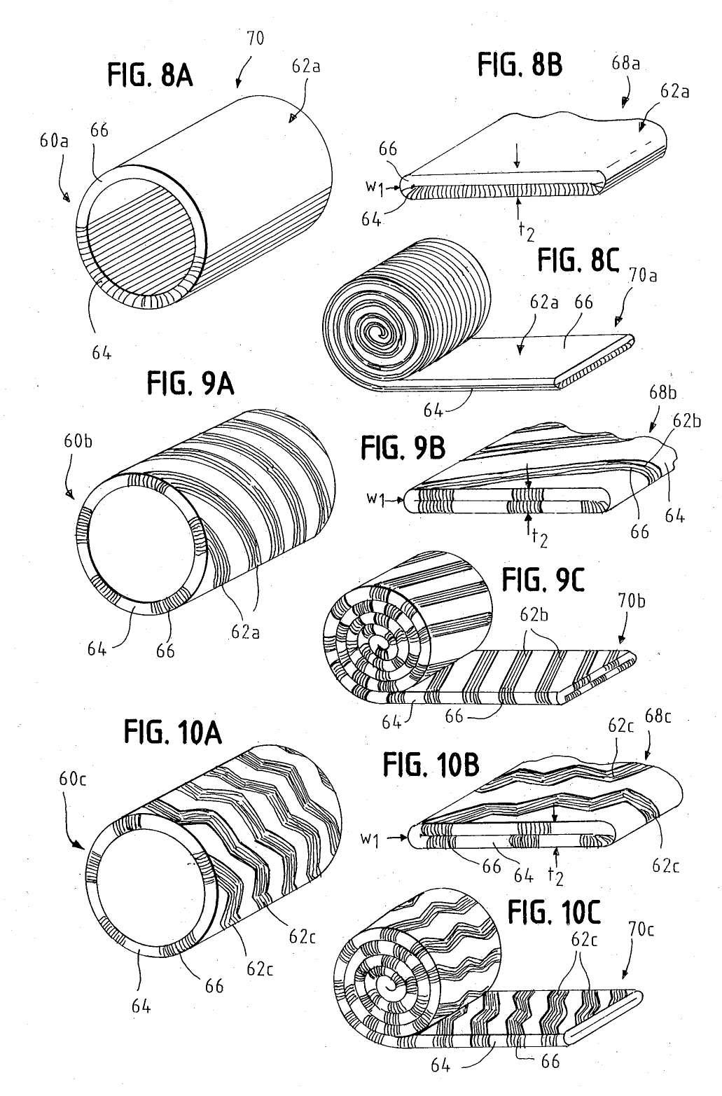

In an embodiment, the rotary valve 18 may be selectively rotated such that the second confectionery material 66 is in fluid communication with only notches 48 of the rotary valve 18 that are aligned, or placed in fluid communication, with corresponding ports 57 that are located on the upper half of the housing 20. The pin 32 of the mandrel 14 may have a smooth outer surface 36 such that the flow of the first confectionery material 64 is straight or substantially straight along the path of the first passageway 26. The actuator 22 and rotary valve 18 may remain in stationary positions, thereby producing an annular extrudate 60a having segmented portions 62a of the second confectionery material 66 formed as a continuous path of the second confectionery material 66 on the upper half of the extrudate 60a and the lower half of the extrudate 60a is formed of the first confectionery material 64, as shown in FIG. 8A. The extrudate 60a may then be formed into a slab 68a, as shown in FIG. 8B, by passing the tubular extrudate 60a through opposing rollers (not shown) that compress, or join, the upper and lower halves of the extrudate 60a. The slab 68a may be further processed by being transferred through more rollers (not shown) to decrease the overall thickness t₂ and increase the overall width w₁ of the slab 68a. Once the slab 68a has been pressed to a desired thickness and width, the slab 68a may then be cut into multiple elongated strips having the desired pattern of segmented portions 62a of the second confectionery material 66 selectively located in the first confectionery material 64, as shown in FIG. 8C, thereby forming a finished confectionery article 70a.

In another embodiment, the rotary valve 18 may be selectively rotated such that the second confectionery material 66 is in continuous fluid communication with spaced-apart notches 48 of the rotary valve 18 that are aligned, or placed into fluid communication, with the second passageway 55 or corresponding ports 57 located in the housing 20, as illustrated in FIGS. 7B and 7D. The pin 32 of the mandrel 14 may have an outer surface 36 having helical grooves 35 (FIG. 6A) formed therein such that the flow of the first confectionery material 64 about the pin 32 is in a helical manner. The actuator 22 and rotary valve 18 may remain in stationary or substantially stationary positions, thereby producing an annular extrudate 60b in which the second confectionery material 66 produces a plurality of continuous, linear segmented portions 62b in the first confectionery material 64 in the form of helical strands of the second confectionery material 66 disposed between similar strands of the first confectionery material 64, as shown in FIG. 9A. The extrudate 60b may then be formed into a slab 68b, as shown in FIG. 9B, by passing the tubular extrudate 60b through opposing rollers (not shown) that compress, or join, the upper and lower halves of the extrudate 60b. The slab 68b may be further processed by being transferred through more rollers (not shown) to decrease the overall thickness t₂ and increase the overall width w₁ of the slab 68b. Once the slab 68b has been pressed to a desired thickness and width, the slab 68b may then be cut into multiple elongated strips having the desired pattern of segmented portions 62b of the second confectionery material 66 selectively located in the first confectionery material 64, as shown in FIG. 9C, thereby forming a finished confectionery article 70b.

In another embodiment, the rotary valve 18 may be selectively rotated such that the second confectionery material 66 is in constant fluid communication with spaced-apart notches 48 of the rotary valve 18 that are continuously aligned, or placed in continuous fluid communication, with the second passageway 55 located in the housing 20, as illustrated in FIG. 7B. The pin 32 of the mandrel 14 has a smooth outer surface (FIG. 3) such that the first confectionery material 64 flows along the first passageway 26 in a linear or substantially linear manner. The actuator 22 and rotary valve 18 may be rotated at a constant angular velocity about the pin 32, thereby producing an annular extrudate 60b having a plurality of continuous helical segmented portions 62b of the second confectionery material 66 in the first confectionery material 64. The tubular extrudate 60b may have alternating strands of the first and second confectionery materials 64, 66, as shown in FIG. 9A. The extrudate 60b may then be formed into a slab 68b, as shown in FIG. 9B, by passing the tubular extrudate 60b through opposing rollers (not shown) that compress, or join, the upper and lower halves of the extrudate 60b. The slab 68b may be further processed by being transferred through more rollers (not shown) to decrease the overall thickness t₂ and increase the overall width w₁ of the slab 68b. Once the slab 68b has been pressed to a desired thickness and width, the slab 68b may then be cut into multiple elongated strips having the desired pattern of segmented portions 62b of the second confectionery material 66 selectively located in the first confectionery material 64, as shown in FIG. 9C, thereby forming a finished confectionery article 70b.

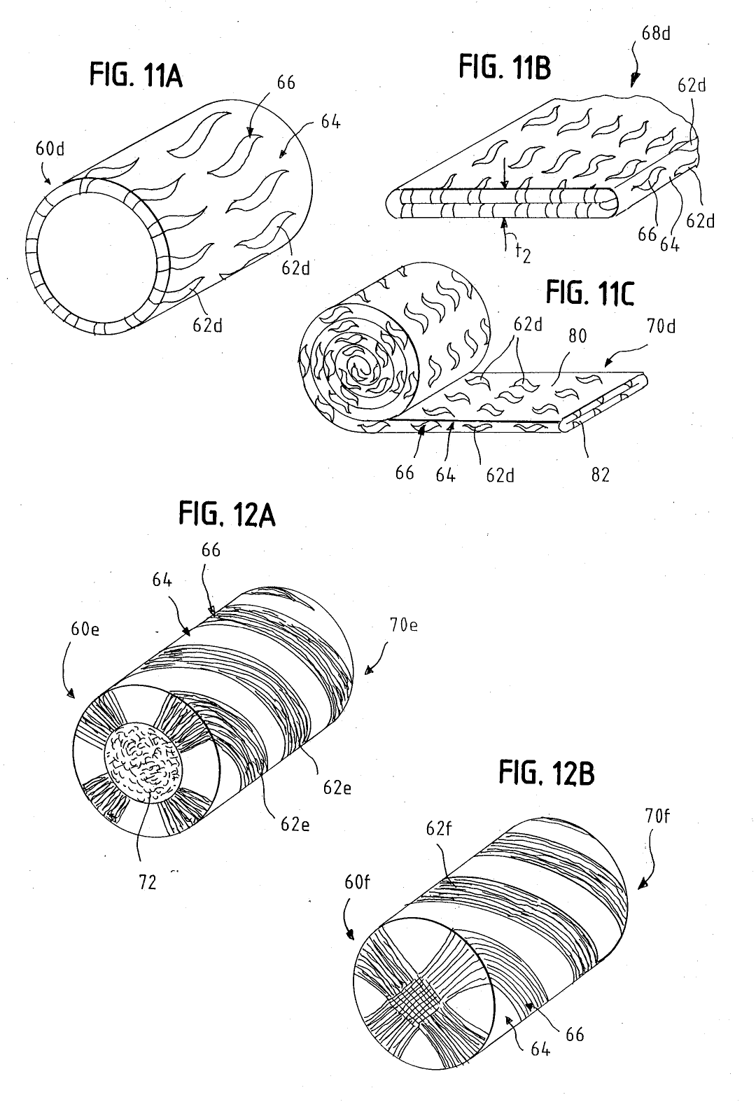

In another embodiment, the actuator 22 and rotary valve 18 may be selectively rotated such that the second passageway 55 is in constant fluid communication with spaced-apart notches 48 of the rotary valve 18, as illustrated in FIG. 7B. The pin 32 of the mandrel 14 may have an outer surface 36 having helical grooves 35 (FIG. 6A) formed therein such that the flow of the first confectionery material 64 about the pin 32 is in a helical manner. The actuator 22 and rotary valve 18 may be rotated about the pin 32 in a reciprocal, alternating clockwise and counter-clockwise manner, thereby producing an annular extrudate 60c having a plurality of continuous zig-zag shaped segmented portions 62c of the second confectionery material 66 within the first confectionery material 64. The extrudate 60c produced includes alternating strips of the first and second confectionery materials 64, 66 in a zig-zag pattern, as shown in FIG. 10A. The extrudate 60c may then be formed into a slab 68c, as shown in FIG. 10B, by passing the tubular extrudate 60c through opposing rollers (not shown) that compress, or join, the upper and lower halves of the extrudate 60c. The slab 68c may be further processed by being transferred through more rollers (not shown) to decrease the overall thickness t₂ and increase the overall width w₁ of the slab 68c. Once the slab 68c has been pressed to a desired thickness and width, the slab 68c may then be cut into multiple elongated strips having the desired pattern of segmented portions 62c of the second confectionery material 66 selectively located in the first confectionery material 64, as shown in FIG. 10C, thereby forming a finished confectionery article 70c.

In another embodiment, the actuator 22 and the rotary valve 18 may be selectively rotated about the pin 32 such that the notches 48 of the rotary valve 18 are moved into and out of alignment, or placed into and out of fluid communication, with corresponding ports 57, as illustrated in FIG. 7D. In an embodiment, the pin 32 of the mandrel 14 may have an outer surface 36 having helical grooves 35 (FIG. 6A) formed therein such that the flow of the first confectionery material 64 about the pin 32 is in a helical manner. The actuator 22 and rotary valve 18 may be rotated in a random manner in the clockwise and counter-clockwise directions such that as the rotary valve 18 is rotated, notches 48 in the rotary valve 18 may be placed into and out of alignment, or placed into and out of fluid communication, with corresponding ports 57 in the housing 20, thereby starting and stopping, respectively, the extrusion of the second confectionery material 66 into the first passageway 26. As a result, an annular extrudate 60d may be produced in which random, non-continuous segmented portions 62 of the second confectionery material 66 are formed in the first confectionery material 64, as shown in FIG. 11A. The extrudate 60d may then be formed into a slab 68d, as shown in FIG. 11B, by passing the tubular extrudate 60d through opposing rollers (not shown) that compress, or join, the upper and lower halves of the extrudate 60d. The slab 68d may be further processed by being transferred through more rollers (not shown) to decrease the overall thickness t₂ and increase the overall width w₁ of the slab 68d. Once the slab 68d has been pressed to a desired thickness and width, the slab 68d may then be cut into multiple elongated strips having the desired pattern of segmented portions 62d of the second confectionery material 66 selectively located in the first confectionery material 64, as shown in FIG. 11C, thereby forming a finished confectionery article 70d.

In another embodiment, the mandrel 14 of the confectionery forming apparatus 10 may be replaced with a mandrel 14 (FIG. 6B) having a third passageway 37 formed through the center thereof. The outer surface 36 of the mandrel 14 is smooth such that the first confectionery material may flow along the outer surface 36 in a linear or substantially linear manner. The notches 48 in the rotary valve may be in continuous alignment, or placed in continuous fluid communication, with the second passageway 55 located about the aperture 50 in the housing 20, as shown in FIG. 7B. Rotation of the rotary valve 18 about the pin 32 at a constant angular velocity may provide a continuous extrusion of the second confectionery material 66 into the first passageway 26, thereby producing a tubular extrudate 60e having continuous segmented portions 62e of the second confectionery material 66 formed as helical strands within the first confectionery material 64, as illustrated in FIG. 12A. As the tubular extrudate 60e exits the confectionery forming apparatus 10, a third confectionery material 72 may be dispensed through the third passageway 37 of the mandrel 14. The third confectionery material 72 may be injected into the center of the extrudate 60e to form an inner layer of material within the outer extrudate. In an embodiment, the extrudate 60e may be immediately cut into individual pieces and wrapped for sale. In another embodiment, the extrudate 60e may be transferred for further processing.

In another embodiment, the mandrel 14 of the confectionery forming apparatus 10 may be removed such that the first confectionery material 64 flows through the first passageway 26 to form a cylindrical or substantially cylindrical extrudate shaped as a rope. The notches 48 in the rotary valve may be in continuous alignment, or placed in continuous fluid communication, with the second passageway 55 located about the aperture 50 in the housing 20, as shown in FIG. 7B. Constant rotation of the rotary valve 18 about the pin 32 may provide a continuous extrusion of the second confectionery material 66 into the first passageway 26, thereby producing a cylindrical extrudate 60f having continuous segmented portions 62f of the second confectionery material 66 formed as helical strands within the first confectionery material 64, as illustrated in FIG. 12B. In an embodiment, the extrudate 60f may be cut into individual pieces and wrapped for sale. In another embodiment, the extrudate 60f may be formed transferred for further processing. It is understood that in any of the aforementioned embodiments, housing 20 may be configured to introduce one, two, or more than two confectionery materials into first confectionery material 64 as previously discussed herein.

Once the extrudate 60 exits the confectionery forming apparatus 10 it may be processed by being cut into pieces and wrapped for sale. In another embodiment, the extrudate 60 may be further processed, as explained above, by compressing the extrudate 60 into a slab having a width and a thickness. The slab may then be transferred through a series of rollers that further compress the slab, thereby decreasing the thickness and increasing the width of the slab. Once the slab has been formed to a desired width and thickness, the slab may be cut into elongated strips that form the finished confectionery article 70. Confectionery article 70a-70f may be formed into any shape as desired. In an embodiment, confectionery article may be a multiple phase chewing gum in the form of a tape, a rolled tape, in stick form, or a filled confectionery article. Confectionery article 70a-70f may have any pattern as herein described and depicted in FIGS. 8A-12B, for example.

The confectionery article 70 may include a top surface 80 and a bottom surface 82, as illustrated in FIG. 11C (confectionery article 70d) as an exemplary embodiment. Because the extrudate 60 includes segmented portions 62 of the second confectionery material disposed within the first confectionery material, when the extrudate 60 is compressed, the top and bottom surfaces 80, 82 of the finished confectionery article 70d include a pattern thereon. The pattern of segmented portions 62 of the second confectionery material 66 on the top surface is different than the pattern of segmented portions on the bottom surface. For example, FIG. 8C illustrates a confectionery article 70a in which the top surface includes segmented portions of the second confectionery material in which the second confectionery material covers the entire top surface 80. This pattern may be the same or different than the pattern on the bottom surface 82 in which the pattern has no segmented portions of the second confectionery material. For another example, FIGS. 9C and 10C illustrate respective confectionery articles 70b and 70c in which the segmented portions 62b and 62c are formed as continuous strands or helical. When the extrudate 60 is compressed, the helical segmented portions become generally aligned linear segments between opposing lateral edges, but the angle of the segmented portions across the top surface 80 relative to the opposing lateral edges are aligned in the opposite direction than the angle of segmented portions on the bottom surface 82. It should be understood by one skilled in the art that the compression of the slab 72 may cause the pattern of segmented portions 62 on the top surface 80 to be different than the pattern of segmented portions 62 on the bottom surface 82 of the confectionery article 70.

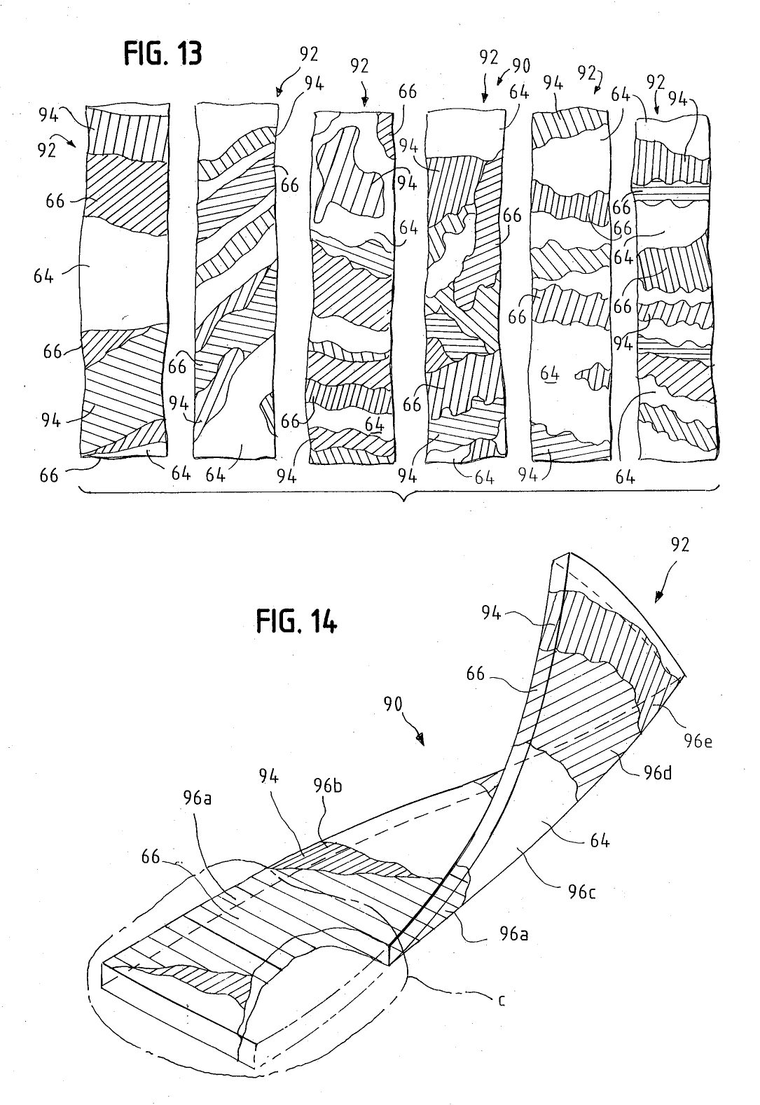

In an embodiment, apparatus 10 may be used to make a confectionery article 90 which may be shaped into one or more sticks 92 as shown in FIGS. 13 and 14. Confectionery article 90 may be any confectionery material as previously described herein. In an embodiment, confectionery article 90 may be a chewing gum. Each stick 92 may include a random pattern of two or more confectionery materials. In an embodiment, each stick may include first confectionery material 64, second confectionery material 66, and a third confectionery material 94, each material randomly disposed within the body of each stick 92. Although FIGS. 13 and 14 show a three-phase confectionery article, one of ordinary skill in the art will appreciate that apparatus 10 may be used to form a confectionery article having two, three, four, five, or more confectionery materials randomly dispersed throughout the body of confectionery article 90.

In an embodiment, each confectionery material 64, 66, and 94 may be a chewing gum having a different visual appearance (i.e., a different color) and/or different organoleptic properties (i.e., flavor, texture, mouthfeel). In a further embodiment, one, some, or each confectionery material 64, 66, and 94 may extend through the entire thickness of stick 92 as shown in FIG. 14. For example, each confectionery material 64, 66, and 94 in stick 92 may be considered a random segment 96, each random segment 96a-96e extending through the entire thickness of stick 92. Section C of FIG. 14 shows a cut-away view of stick 92. Section C shows random segment 96a extending through the entire thickness of stick 92. In addition, segment 96a extends across the entire width of stick 92. Consequently, random segment 96a, as well as random segments 96b-96e, may be visible from a bottom surface, a top surface and optionally one or more side surfaces of stick 92 as shown in FIG. 14. An advantage of confectionery article 90 (as well as confectionery article 70) is that the body of the confectionery article is a coextrusion or molding of two or more confectionery materials which form an integral body, the body having a plurality of different confectionery segments dispersed (randomly or predetermined) therein.

In an embodiment, each stick 92 may be individually wrapped and packaged with a plurality of other individually wrapped sticks 92 (i.e., in 5-stick packs, 10-stick packs or as is otherwise commonly known in the art) to form a packaged confectionery product of individually wrapped confectionery articles. Each stick 92 in the pack may carry or depict a unique random pattern of a plurality of confectionery materials as described above. Confectionery article 90 thereby advantageously provides heightened interest to confectionery consumption. Upon unwrapping each individual stick, the consumer enjoys the surprise of viewing a unique, original, non-duplicated, dissimilar visual appearance conveyed by the random pattern carried by each stick 92. The randomness of each confectionery material may also provide each stick 92 with a unique combination of organoleptic properties. Each confectionery material 64, 66, and 94 may contain a corresponding flavor. The random presence of each confectionery material 64, 66, and 94 in each stick 92 may provide each stick a unique proportion of each flavor, thereby providing each stick a unique flavor profile when consumed.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

The invention is claimed as follows:

1. An apparatus comprising:
a first passageway for receiving a first confectionery material; and
a rotary valve surrounding the first passageway, the rotary valve receiving a second confectionery material, and the rotary valve extruding the second confectionery material into the first confectionery material.

2. The apparatus of claim 1, wherein the rotary valve is rotatable about the first passageway.

3. The apparatus of claim 1, wherein the second confectionery material is continuously or non-continuously extruded from the rotary valve.

4. The apparatus of claim 1, wherein the first and second confectionery materials form a tubular extrudate.

5. The apparatus of claim 1, wherein the second confectionery material is extruded to form a pattern of the second confectionery material in the first confectionery material.

6. The apparatus of claim 1, wherein the second confectionery material is extruded to helical strands in the first confectionery material.

7. The apparatus of claim 1, wherein the second confectionery material is extruded to form zig-zag strands in the first confectionery material.

8. The apparatus of claim 1, wherein the first confectionery material has a visual appearance different than a visual appearance of the second confectionery material.

9. An apparatus comprising:
a first passageway for receiving a first confectionery material;
a rotary valve receiving a second confectionery material, the rotary valve surrounding the first passageway and extruding the second confectionery material into the first confectionery material; and
a mandrel receiving a third confectionery material, the first passageway surrounding the mandrel, and the third confectionery material dispensable within an extrudate formed of the first and second confectionery materials.

10. The apparatus of claim 9, wherein an outer surface of the mandrel includes a plurality of helical grooves.

11. The apparatus of claim 9, wherein the mandrel is replaceable.

12. An apparatus comprising:
a first passageway for receiving a first confectionery material;
a rotary valve receiving a second confectionery material, the rotary valve surrounding the first passageway; and
a plurality of notches formed in the rotary valve, the notches movable into and out of fluid communication with the second confectionery material, the notches selectively extruding the second confectionery material into the first confectionery material.

13. The apparatus of claim 12, wherein rotation of the rotary valve places the notches into or out of fluid communication with the second confectionery material.

14. The apparatus of claim 12, wherein the notches are in continuous fluid communication with the second confectionery material.

15. The apparatus of claim 12, wherein the notches are in non-continuous fluid communication with the second confectionery material.

16. The apparatus of claim 12, wherein rotation of the rotary valve starts or stops extrusion of the second confectionery material through the notches.

17. An extrusion method comprising:
extruding a first confectionery material through a conduit, the conduit surrounded by a rotary valve; and
extruding the second confectionery material through the rotary valve into the first confectionery material.

18. The method of claim 17, further comprising rotating the rotary valve to form a multiple phase pattern with the first and second confectionery materials.

19. The method of claim 17, further comprising continuously rotating the rotary valve to form helical strands of the second confectionery material in the first confectionery material.

20. The method of claim 17, further comprising rotating the rotary valve to form zig-zag shaped strands of the second confectionery material in the first confectionery material.

21. The method of claim 17, further comprising rotating the rotary valve to form a random pattern of the second confectionery material in the first confectionery material.

22. A confectionery article comprising:
a substantially flat body having a top surface and a bottom surface, the body including at least a first confectionery material and a second confectionery material forming a pattern on the top and bottom surfaces, the pattern on the top surface being different than the pattern on the bottom surface.

23. The confectionery article of claim 22, wherein the body includes opposing lateral edges and the second confectionery material forms strands extending between the opposing lateral edges.

24. The confectionery article of claim 22, wherein the second confectionery material forms zig-zag shaped strands in the first confectionery material.

25. The confectionery article of claim 22, wherein the second confectionery material forms a random pattern in the first confectionery material on the top and bottom surfaces.

26. The confectionery article of claim 22, wherein the first and second confectionery materials have different visual appearances.

27. A confectionery article comprising:
a tubular body, the body including a design having portions of a first confectionery material formed within a second confectionery material.

28. The confectionery article of claim 27, wherein the first confectionery material forms substantially linear strands within the second confectionery material.

29. The confectionery article of claim 27, wherein the first confectionery material forms non-continuous portions within the second confectionery material.

30. The confectionery article of claim 27, further comprising a third confectionery material disposed within the tubular body.
